(19) United States
(12) Patent Application Publication
(10) Pub. No.: US 2009/0101234 A1
(43) Pub. Date: Apr. 23, 2009

(54) STUMP CUTTER WITH A WEIGHT CENTERED POWER TRAIN

(76) Inventor: Richard L. HART, Dalton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/874,304

(22) Filed: Oct. 18, 2007

(51) Int. Cl. A01G 23/06

(52) U.S. Cl. 144/24.12; 37/302

(57) ABSTRACT

A stump cutter configured for improved stability includes a frame structure, an engine, a boom with a proximal end and distal end, and a grinding wheel rotatably mounted to the distal end of the boom. The boom is pivotally mounted to the frame structure at its proximal end typically by means of a turntable, hydraulic actuators and ears. Preferably, the engine is pivotally mounted between the ears about a generally horizontal axis so that the engine is generally weight-balanced during pivoting. The horizontal axis preferably passes through or adjacent the engine's center of mass.

### BACKGROUND OF THE INVENTION

1. Technical Field

The invention relates to landscaping and tree removal. More particularly, the invention relates to a stump cutter for grinding tree stumps. Furthermore, the invention provides increased stability for a stump cutter through a weight centered power train.

2. Background Information

After a tree has been felled, the tree stump is usually a small remaining portion of the trunk with the roots still in the ground. Tree stumps can be very difficult to remove. They can be dug out of the ground using a pick and shovel or they can be shaved down using a stump cutter to remove the portion of the stump above the soil. After the stump is ground down below the soil line, soil can be placed over the remaining portion to allow grass or crops to grow.

A stump cutter is a stand-alone power tool machine or equipment attachment that removes tree stumps by means of a rotating cutting wheel having a cutting disk and fixed rigid teeth extending radially outward therefrom which chip away the wood. Typically the grinding wheel is swept back and forth in a generally horizontal plane across the tree stump. With each sweep, the grinding wheel is lowered slightly to remove another layer of the stump with the next pass. An engine, typically a gasoline or diesel engine, located on the wheeled frame generates power to drive the grinding wheel.

In one common stump cutter design, the cutter boom and engine are attached to a turntable. The turntable is free to swing side to side, and the engine sits transverse in respect to the cutter boom. Often, the engine has a belt drive going back to a jackshaft, which is a hinge point for a second portion of the cutter boom. This second hinge point allows the boom to raise and lower. The drawback to this design is that the boom is very long in order to clear the wheels of the chassis. Additionally, maintenance of the jackshaft bearings adds time and expense to this configuration.

Another typical stump cutter design allows the cutter boom to support the engine. The cutter boom swings in a “pivot head” that can tilt fore and aft relative the chassis to raise and lower the cutter wheel. The engine pivots about a horizontal axis which is below and forward of the engine, which causes the engine to move a lot in relation to the chassis. This large amount of movement causes the machine's center of mass to move while in operation, which can lead to the stump cutter upsetting and rolling to its side, possibly causing injury. The larger amount of movement also leads to designing a lot of clearance beneath the engine/boom, which elevates the machine's center of mass.

Thus a stump cutter is needed which maintains stability throughout the movement of the stump cutter boom and blade.

### BRIEF SUMMARY OF THE INVENTION

A stump cutter comprising: a frame; a boom pivotally mounted on the frame about a substantially horizontal axis; a grinding wheel rotatably mounted on the boom; and an engine mounted on the boom and pivotable therewith wherein the horizontal axis passes through the engine.

### BRIEF DESCRIPTION OF THE SEVERAL VIEWS OF THE DRAWINGS

A preferred embodiment of the invention illustrated of the best mode in which Applicant contemplates applying the principals, is set forth in the following description and is shown in the drawings and is particularly and distinctly pointed out and set forth in the appended claims.

FIG. 1 is a side elevational view of the stump cutter.

FIG. 2 is an enlarged side elevational view of a portion of the stump cutter with the engine shown in phantom.

FIG. 3 is a top plan view of the portion of the stump cutter shown in FIG. 2 with the engine removed;

FIG. 4 is similar to FIG. 3 and shows the boom pivoting to one side.

FIG. 5 is similar to FIG. 4 and shows the boom pivoting to the other side.

FIG. 6 is a sectional view taken on line 6-6 of FIG. 2.

FIG. 7 is a side elevational view of the boom pivoting upwards with the engine shown in phantom.

FIG. 8 is similar to FIG. 7 and shows the boom pivoting downwards.

Similar numbers refer to similar parts throughout the drawings.

### DETAILED DESCRIPTION OF THE INVENTION

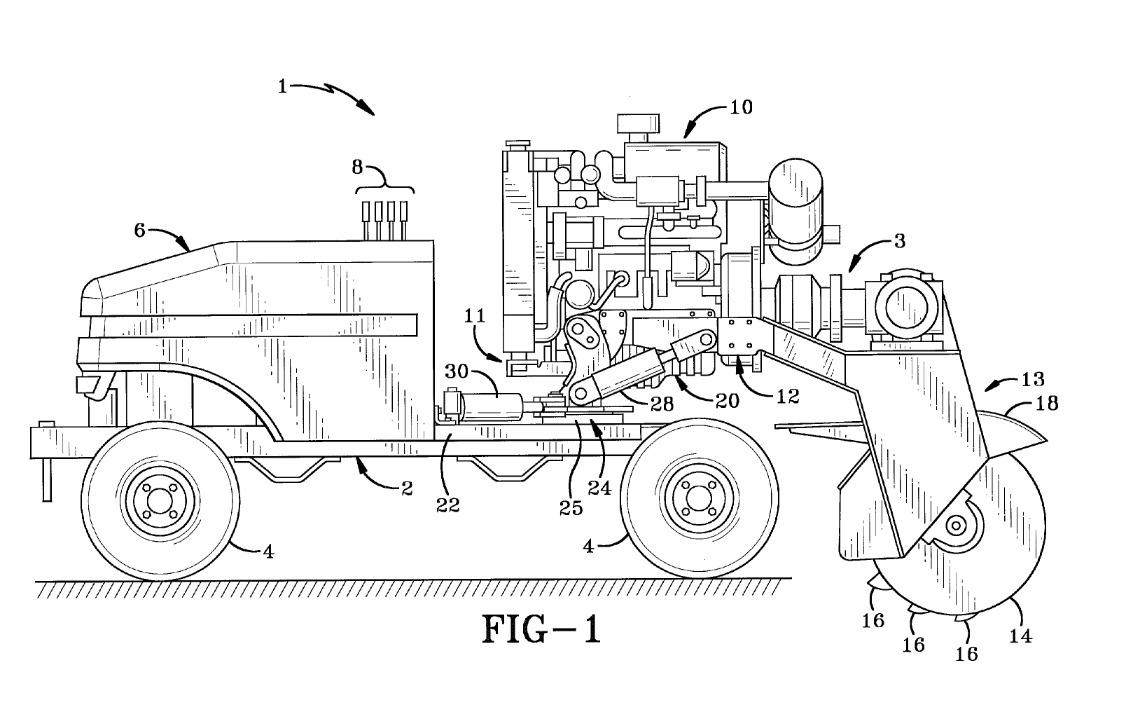

The stump cutter of the present invention is shown generally at 1 in FIG. 1. Stump cutter 1 has a weight centered powertrain 3 constructed in accordance with the present invention. As shown, stump cutter 1 also includes a frame or chassis 2 supported by a plurality of wheels 4 to facilitate movement of stump cutter 1 from place to place. A control housing 6 is mounted on chassis 2 with protruding control levers 8.

Power train 3 includes an engine 10, a boom 12 having first and second ends 11 and 13, a clutch and brake system, a gearbox 20 and a grinding wheel 14. Engine 10 and grinding wheel 14 are mounted on boom 12 respectively adjacent first and second ends 11 and 13. Engine 10 is proximal housing 6 and drives the clutch and brake system, which drives gearbox 20. Gearbox 20 drives rotation of grinding wheel 14 via a belt and chain system to provide the torque needed for the radially extending teeth 16 of wheel 14 to grind down a stump. Grinding wheel 14 is partially surrounded by a debris protector 18.

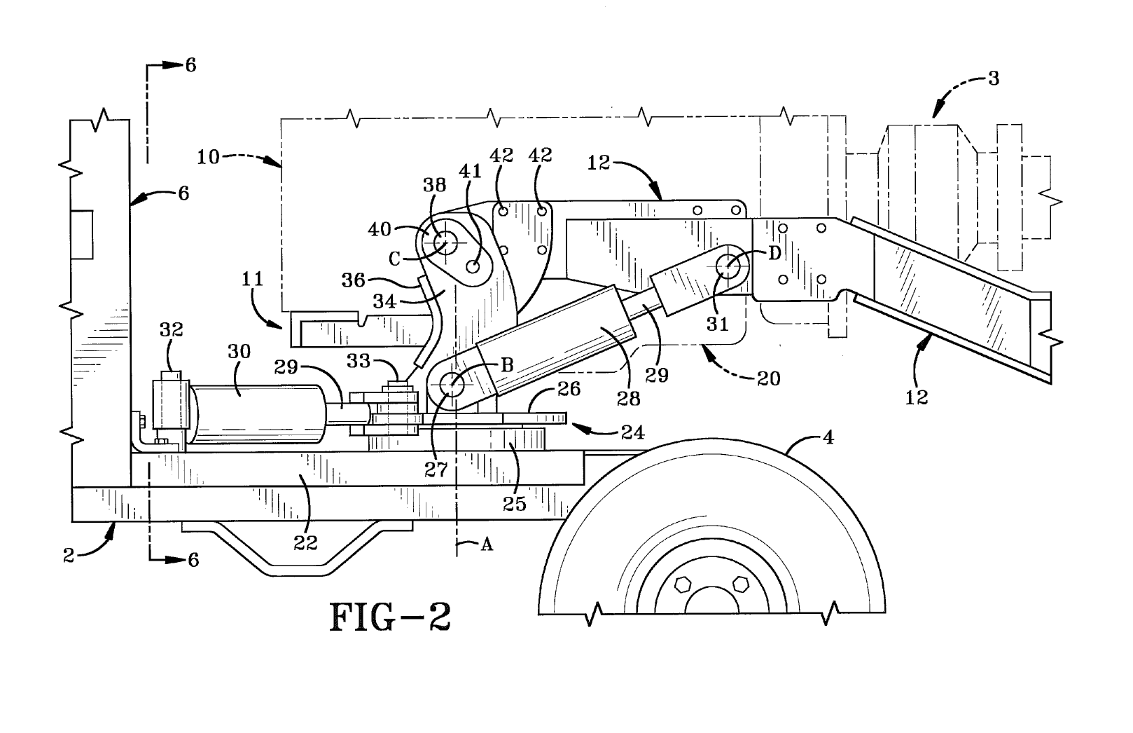

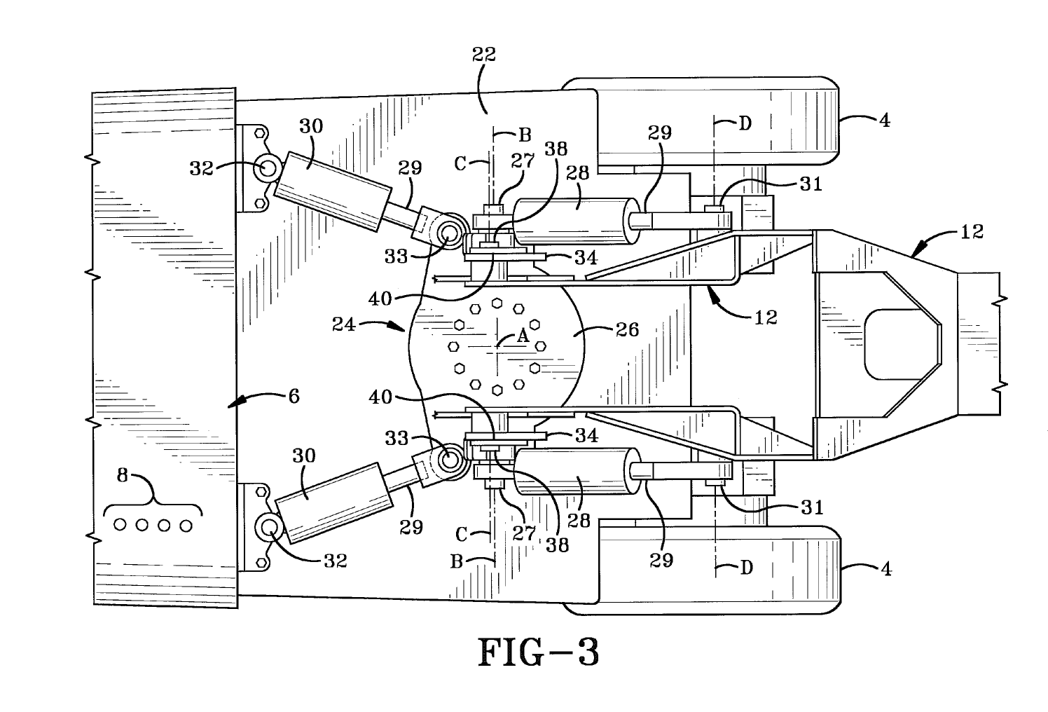

Referring to FIGS. 1-3, the mounting of boom 12 on chassis 2 is described in further detail. A boom platform 22 is mounted on chassis 2 and a turntable assembly 24 is mounted on platform 22. Turntable assembly 24 includes a turntable 26, which is typically a substantially flat horizontal plate rotatable about a substantially vertical axis A that passes through engine 10, as well as a bearing 25 for rotational movement. As shown in FIGS. 2-3, a pair of axially spaced ears 34 is connected to and extends upwardly from turntable 26. It will be understood that while turntable 26 and ears 34 are shown to be substantially separate, these elements may be fabricated as a single unit in a cradle shape.

A stub plate 40 is fastened to each ear 34 by a stub bolt 41, and securely holds a stub axle 38 to ear 34. An ear support bracket 36 reinforces ear 34 and allows ear 34 to support a large amount of weight. First end 11 of boom 12 is pivotally connected to ears 34 via pivots or stub axles 38 about a substantially horizontal axis C passing through axles 38. Boom 12 is attached to engine 10 by a plurality of bolts 42, as well as stub axles 38. Stub axle 38 holds a substantial amount of the total engine 10 weight and helps to stabilize the system by securing engine 10 weight on the generally neutral pivot axis C.

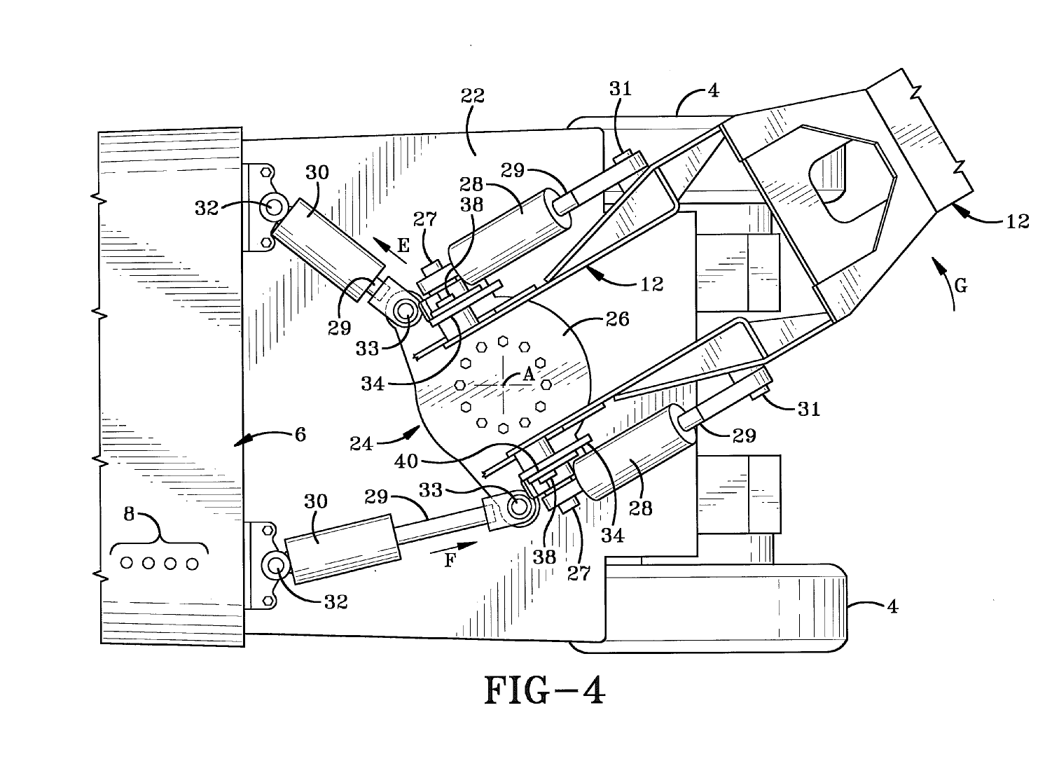

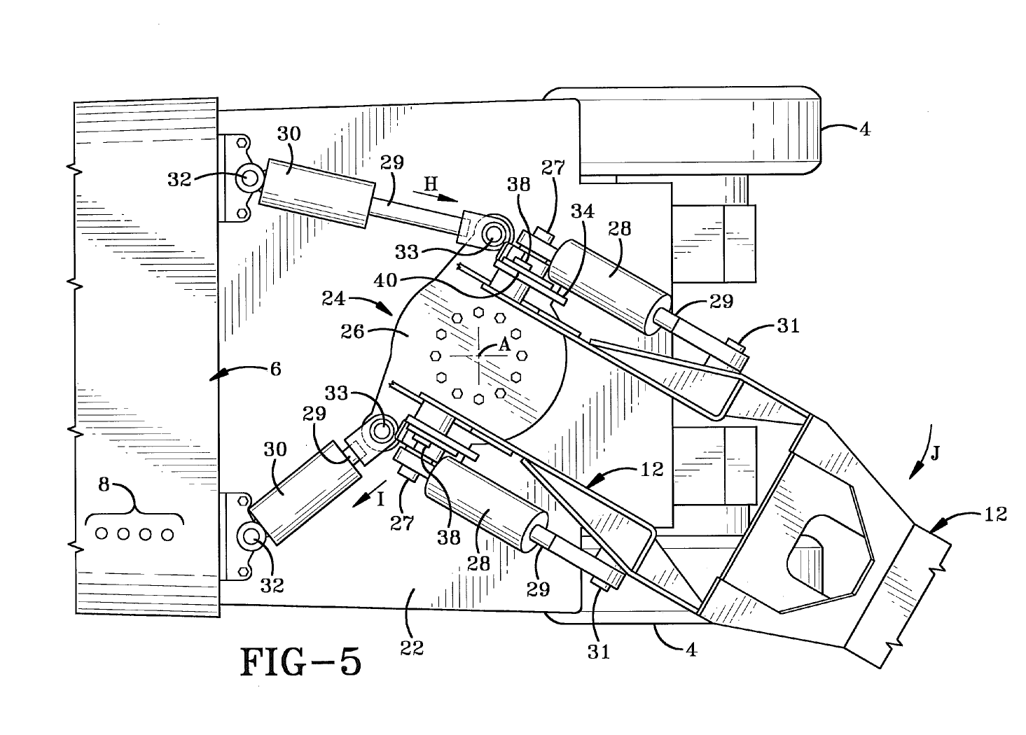

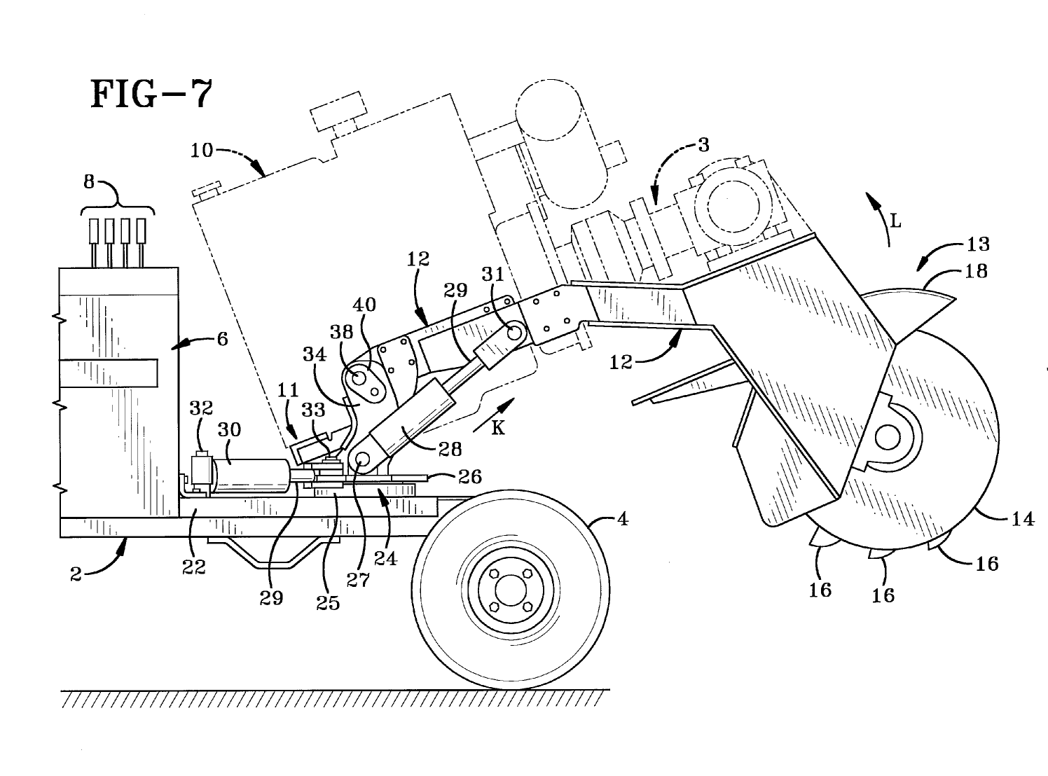

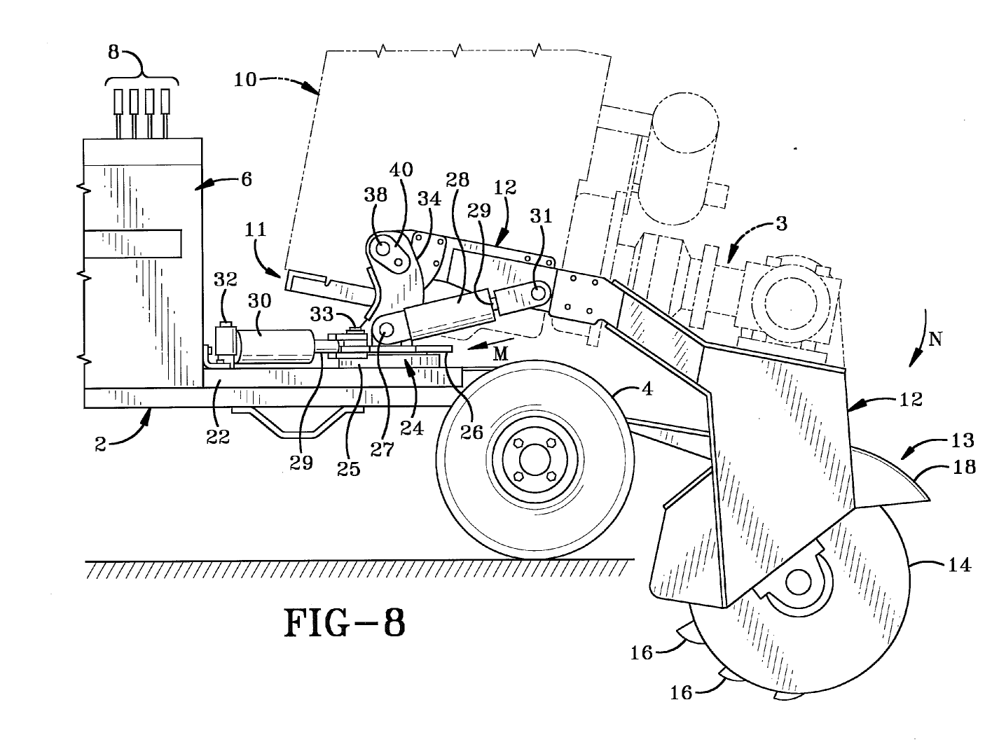

A first pair of hydraulic actuators 28 are pivotally mounted adjacent first ends thereof on turntable 26 about a substantially horizontal axis B at respective pivots 27. The opposite ends of actuators 28 are pivotally connected to boom 12 about a substantially horizontal axis D at pivots 31. Actuators 28 enable upward and downward movement of boom 12 so that boom 12 is pivotable about axis C between a lowered position (FIG. 8) and a raised position (FIG. 7). A second pair of hydraulic actuators 30 is also pivotally connected adjacent respective first ends to platform 22 at pivots 32 and adjacent opposite ends thereof to turntable 26 at pivots 33. Actuators 30 serve to rotate boom 12 laterally between a first lateral position shown in FIG. 4 (arrows E, F, G) and a second opposite lateral position shown in FIG. 5 (arrows H, I, J). Hydraulic actuators 28 and 30 each house a piston 29 that can extend or retract.

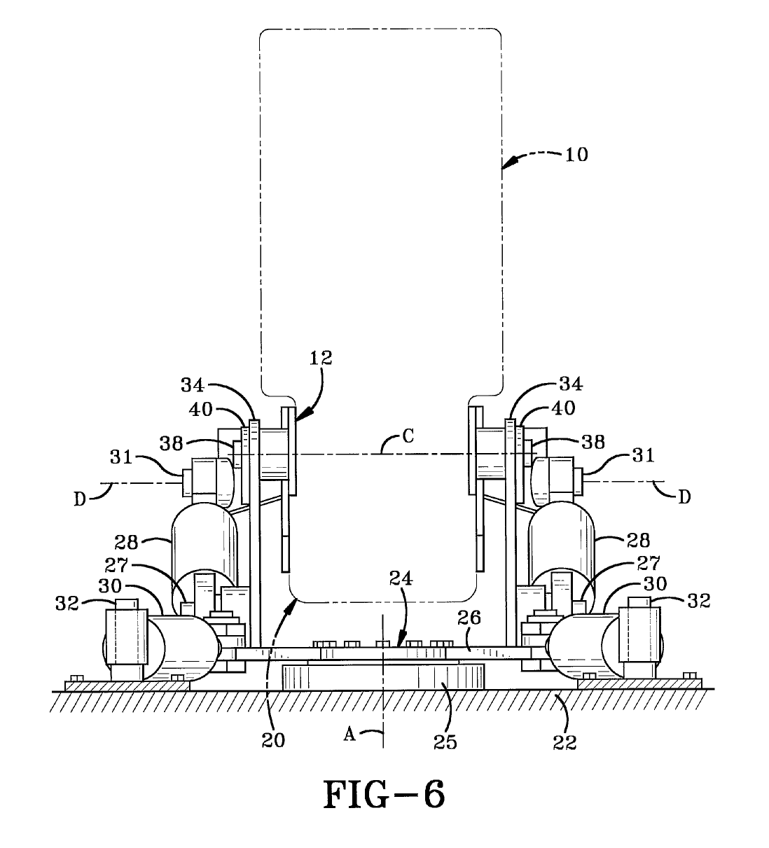

In accordance with the present invention, axis C passes through engine 10 such that while boom 12 moves, its weight stays balanced and stable to ensure safe operation. As shown in FIG. 6, lateral axis C about which boom 12 rotates extends through or adjacent the center of mass of engine 10. Vertical axis A, as shown in FIG. 3, extends through or adjacent the center of mass of engine 10 as well, intersecting axis C. The bulk of the weight of engine 10 is supported by stub axle 38. With the weight evenly distributed, the engine remains relatively neutrally balanced in response to moving and pivoting of the boom 12 in any direction while in operation.

In a preferred mode of operation, the user fells a tree and moves stump cutter 1 close to the stump by way of wheels 4. The user stands behind control housing 6, so as to manipulate control levers 8. From this position, the operator can vary engine 10 speed, start and stop grinding wheel 14, as well as vary cutting speed. Still from this position, the user may vertically lower and raise the grinding wheel 14 and swing the cutting wheel back and forth horizontally.

After the user has positioned stump cutter 1 near a stump, he activates control lever 8 that controls gearbox 20 and starts rotation of grinding wheel 14. Grinding wheel 14 is then lowered to a position below the level of the top of the stump, to one side of the stump. Activating one of control levers 8, which controls hydraulic actuators 28, retracts piston 29 and pulls boom 12 downward by pivoting on stub axle 38 to lower the boom. The vertical movement is stable and balanced due to engine 10 center of mass resting directly on or adjacent the pivot point for boom 12. Boom 12 moves and pivots easily, while still maintaining balance as well as weight on grinding wheel 14 to dampen grinding feedback.

After boom 12 is lowered and grinding wheel 14 is proximate to the stump, the user engages control lever 8, which moves the boom 12 horizontally across the top of the stump. When the spinning teeth 16 on grinding wheel 14 come into contact with the stump, wood is chipped away by teeth 16 and removed from the stump. One of levers 8 controls actuators 30 to move boom 12 horizontally from one side of the stump to the other to remove a layer of wood. Piston 29 in actuators 30 alternately push and pull in concert on turntable 26 and move boom 12 from one side to the other, while actuators 28 hold the horizontal plane constant and steady.

The user continues this procedure of grinding off layers of wood on the tree stump until the stump is level with the ground. At this point, the user will position the grinding wheel directly above the stump and vertically lower grinding wheel onto the stump, by means of actuators 28. This will continue to grind the stump deeper into the ground, ultimately lowering the level of the top of the stump deep enough in the ground to allow a sufficient layer of topsoil to cover it. Grass seed or crops can then be planted evenly over the covered stump and the stump remains will not affect mowing or harvesting operations.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A stump cutter comprising:
a frame;
a boom pivotally mounted on the frame about a substantially horizontal axis;
a grinding wheel rotatably mounted on the boom; and
an engine mounted on the boom and pivotable therewith wherein the horizontal axis passes through the engine.

2. The device of claim 1 further comprising:
first and second opposed ends formed on the boom;
wherein the engine is positioned adjacent the first end of the boom; and
the grinding wheel is positioned adjacent the second end of the boom.

3. The device of claim 1 wherein the engine has a center of mass; and the horizontal axis extends adjacent the center of mass.

4. The device of claim 2 further comprising:
two spaced ears;
wherein the boom is pivotally mounted on the ears; and
wherein at least a portion of the engine is positioned intermediate the two ears.

5. The device of claim 4 further comprising:
a boom actuator having first and second opposed ends;
wherein the first end of the boom actuator is pivotally mounted adjacent one of the ears; and
the second end of the actuator is pivotally mounted on the boom.

6. The device of claim 5 wherein the boom is pivotable about a substantially vertical axis.

7. The device of claim 6 further comprising a turntable for supporting the boom that is pivotable about the vertical axis and supports the ears.

8. The device of claim 7 further comprising:
a turntable actuator having first and second opposed ends;
wherein the first end of the turntable actuator is pivotally mounted to the turntable; and
the second end of the turntable actuator is pivotally mounted to the frame.

9. The device of claim 1 further comprising a boom actuator pivotally mounted on the boom for pivoting the boom up and down.

10. The device of claim 2 wherein the boom is pivotable about a substantially vertical axis.

11. The device of claim 10 further comprising a turntable that is pivotable about the vertical axis and supports the boom.

12. The device of claim 2 further comprising a cradle mounted on the frame for supporting the boom.

13. The device of claim 12 in which the cradle further comprises a pivot plate and a pair of spaced ears extending away from the pivot plate and wherein the boom extends intermediate the ears.

14. The device of claim 13 wherein the horizontal axis passes through the cradle.

15. The device of claim 13 further comprising a vertical pivot having a vertical pivot axis extending through the frame and the pivot plate for pivotally supporting the cradle relative to the frame.

16. The device of claim 15 in which the engine is positioned over the pivot plate.

17. The device of claim 15 in which the vertical pivot axis passes through the engine.

18. The device of claim 15 in which the vertical pivot axis intersects the horizontal pivot axis.

19. The device of claim 10 wherein the engine is substantially weight balanced about the horizontal axis.

20. The device of claim 19 wherein the engine is substantially weight balanced about the vertical axis.
